(19) United States
(12) Patent Application Publication
(10) Pub. No.: US 2009/0160105 A1
(43) Pub. Date: Jun. 25, 2009

(54) Process for Producing an Extruded Shaped Body

(75) Inventors: Manfred Jaeckel, Loxstedt (DE); Georg Kunschert, Pflach (AT); Gebhard Zobl, Schattwald (AT)

Correspondence Address: LERNER GREENBERG STEMER LLP, P O BOX 2480, HOLLYWOOD, FL, 33022-2480, US

(73) Assignee: PLANSEE SE, Reutte (AT)

(21) Appl. No.: 12/349,242

(22) Filed: Jan. 6, 2009

Related U.S. Application Data
(63) Continuation of application No. PCT/AT2007/000328, filed on Jul. 3, 2007.

(30) Foreign Application Priority Data
Jul. 6, 2006 (AT) GM 529/2006

(51) Int. Cl. B28B 3/22

(52) U.S. Cl. 264/639

(57) ABSTRACT

A process for producing a shaped body includes the steps of producing a molding composition, plasticization of the molding composition in an extruder and discharge through a slit die, introduction of the green body into a smoothing calender, smoothing the green body through the use of one or more smoothing processes, chemical and/or thermal binder removal and sintering. The continuous process preferably makes it possible to economically produce sheet products having a high surface quality.

### CROSS-REFERENCE TO RELATED APPLICATION

This is a continuing application, under 35 U.S.C. § 120, of copending International Application No. PCT/AT2007/000328, filed Jul. 3, 2007, which designated the United States; this application also claims the priority, under 35 U.S.C. § 119, of Austrian Patent Application GM 529/2006, filed Jul. 6, 2006; the prior applications are herewith incorporated by reference in their entirety.

### BACKGROUND OF THE INVENTION

### Field of the Invention

The invention relates to a process for producing a shaped body. The production of sheets from sinterable ceramic powders by applying preferably aqueous suspensions in thin layers to suitable substrates using water-soluble polymers or polymer dispersions and subsequently drying them, is known. Metallic sheets can also be produced using the tape casting technique. The tape casting technique has been employed for some decades, usually using aqueous binder systems, for oxide ceramic substrates and is therefore technologically mature due to numerous applications. Thin sheets e.g. in the range of from 0.1 to 0.5 mm, can be produced economically by that process.

At thicknesses above 1 mm, the drying times increase considerably and thickness tolerance and surface roughness are unsatisfactory. Continuous manufacture of sheet products having thicknesses above 1 mm on the basis of aqueous binder systems at acceptable production times is therefore not possible using the tape casting technique. The use of organic solvents as volatile plasticizers for polymers makes a shortening of the production times and an improvement in the product properties possible because of the variety of substances which can be used and adapted to the respective powder properties. However, those advantages are frequently not utilized because of the excessively high costs of a plant construction to suit the solvent and for environmental reasons.

U.S. Patent Application Publication No. US 2006/0039817 describes a process for producing metal sheets. The process includes substantially the steps: production of a feedstock suitable for injection molding, injection molding of the feedstock in metal sheet form and sintering to 100% density. The process is preferably carried out by using horizontal piston presses for uniform application of the high pressing pressures required. The drying times for the extrudates can be up to a number of days, depending on the thickness, because of the risk of crack formation.

The process described above has only limited suitability for the production of thin sheet products because of the low intrinsic strength of the moist extruded mass exiting from the nozzle. That is because, even after the drying process, handling of such thin extrudates is possible only for small dimensions because of the risk of fracture. A continuous production process is not possible through the use of that process.

The technologies which are customary and known at present in the ceramic and powder metallurgical industry therefore do not make it possible to produce sinterable powder sheets, bands, metal sheets and plates in the thickness range from about 0.1 to 10 mm continuously and with high surface quality and narrow thickness tolerance at an acceptable cost.

### SUMMARY OF THE INVENTION

It is accordingly an object of the invention to provide a continuous process for producing an extruded shaped body, which overcomes the hereinafore-mentioned disadvantages of the heretofore-known processes of this general type and through the use of which metallic and ceramic shaped bodies having good mechanical/physical properties and surface quality can be produced economically.

With the foregoing and other objects in view there is provided, in accordance with the invention, a process for producing a shaped body. The process comprises the following steps:
producing a molding composition including from 40 to 70% by volume of metal and/or ceramic powder, from 30 to 60% by volume of a thermoplastic binder and from 0 to 5% by volume of dispersants and/or other auxiliaries;
plasticizing the molding composition in an extruder and producing a green body by discharging molding composition through a slit die;
introducing the green body into a smoothing calender;
smoothing the green body by one or more smoothing processes;
chemically and/or thermally removing binder from the smoothed green body; and
sintering the green body which has been at least partially debindered or freed of binder.

The use of an extruder, discharge through a slit die and introduction of the green body into a smoothing calender, makes it possible to continuously produce shaped bodies having excellent surface quality, narrow thickness tolerances and good product properties.

The molding composition according to the invention includes from 40 to 70% by volume of metal and/or ceramic powder, from 30 to 60% by volume of a thermoplastic binder and from 0 to 5% by volume of dispersants and/or other auxiliaries.

According to the process of the related requirement profile, there is thus the opportunity of modifying the respective molding composition in terms of formulation. In this case it is important that the molding composition has a good homogeneity in the thermoplastic region upon going from the barrel of the extruder into the inlet of the slit die. Uniform flow over the entire width of the die, good melt strength and ductility after leaving the die are prerequisites for precise smoothing of thickness fluctuations during the course of the smoothing process in the smoothing calender.

Thermoplastic binders including a polymer and a plasticizer have been found to be particularly useful for this purpose. Particularly high melt and room-temperature strength and also melt elongation can be achieved using nitrogen-containing polymers, in particular binder systems based on polyurethane and polyamide. In order to set the necessary melt viscosities and to achieve sufficient room-temperature strengths, preference is given to using mixtures of liquid and solid plasticizers. Fatty acids, esters of fatty acids and fatty alcohols have been found to be particularly useful as plasticizers. Changing the chemical nature of the plasticizers, the ratio among them and the ratio of polymer to plasticizer gives sufficient opportunities for matching the formulation to the respective powder materials. The preferred volume ratio of polymer to plasticizer is from 1:1 to 1:5.7. Furthermore, the dispersants and auxiliaries customary in the processing of plasticized powder compositions can be used.

The binders according to the invention give the molding composition good thermoplastic properties at temperatures from 50 to 200° C. The polymers according to the invention result in the molding composition having sufficient strength and elasticity at room temperature. The plasticizer components according to the invention give the molding composition a dry feel without pronounced tendency to stick.

The formulation employed according to the invention prevents undesirable crack formation during the drying process, even at high wall thicknesses. It is possible to feed the green body which has been discharged directly to the smoothing calender. This and the use of an extruder result in a continuous and therefore very economical process for production of the shaped bodies. Furthermore, it is also possible to carry out the binder removal process either chemically, thermally or chemically and thermally and to integrate the subsequent sintering into the process line.

For the present purposes, sintering encompasses all processes which lead to an increase in strength. It does not have to be associated with an increase in the density. Even heat treatment which, for example, leads only to bridge formation between the grains, is therefore encompassed by the term sintering.

In order to ensure a relatively high homogeneity of the molding composition, it is advantageous for this composition to be mixed before extrusion and be kneaded at a temperature in a range of from 60° C. to the decomposition temperature of the respective binder. At temperatures of <60° C., the kneading force becomes too great and the homogeneity of the kneaded composition is insufficient. Suitable extruders are, in particular, single-screw extruders, twin-screw extruders, multiscrew extruders and cascade extruders.

The process of coextrusion, namely a combination of molding composition melts of the same type or different types before leaving the die, which is customary in plastics technology, can also be employed in conjunction with the process of the invention.

Since the highly filled molding compositions according to the invention which have powder contents of from 40 to 70% by volume of metal and/or ceramic powder require highly plasticized polymer systems having a relatively low melting range, a corresponding processing temperature which is from 50 to 200° C., preferably from 60 to 150° C., has to be taken into account in plant construction. This means modification of the plasticizer unit of the extruder by making appropriate changes in the screw and barrel geometry compared to extruders customarily used in the plastics industry, for example by increasing the compression zone of the screw.

In particular, the die construction of the extruder, which is responsible for the uniform flow of the molding composition over the entire working width, has to be adapted. It has been found that the temperature of the exit region of the slit die should preferably be controlled so that the temperature of the molding composition is reduced by from 5 to 30° C. Furthermore, it has been found that process reliability can be increased by using a long parallel part for increasing the pressure of the melt in the exit region. The die gap of the slit die preferably has a height of from 0.5 to 12 mm and a height to width ratio of from 1:9 to 1:600. In the case of slit die heights below 0.5 mm, there is an unacceptably high buildup of pressure and, associated therewith, increased wear. At a height above 12 mm, the excessively low pressure buildup presents difficulties with the flow distribution in the slit die and specially constructed dies, e.g. with significantly lengthened die lip inserts, have to be employed.

In order to achieve a good smoothing action in the smoothing process, the smoothing roller is heated so that the green body in the gap between the rollers has a temperature in the thermoplastic range of the binder. The smoothing process can be carried out through the use of one duo smoothing calender, with the green body being smoothed in one smoothing process. However, it is possible to place a plurality of duo smoothing calenders in series. It has been found to be particularly advantageous for the green body to be smoothed in a trio smoothing calender through the use of two smoothing processes, with the green body resting against the middle smoothing roller between the first and second smoothing processes. The decrease in thickness per smoothing process is advantageously in the range from 0% to 30%. A decrease of 0% means that there is no decrease in thickness but depressions and raised regions on the green body are evened out. If the thickness decrease per smoothing process is >30%, accumulations of material occur before the smoothing roller and, associated therewith, air inclusions result in the green body.

The green body can also be subjected to an embossing process during the course of the smoothing process. This embossing process can also be carried out continuously by use of appropriately structured embossing rollers.

The process of the invention preferably makes it possible to produce smoothed green bodies having a thickness of from 0.1 to 10 mm and a thickness to width ratio of from 1:10 to 1:700.

The smoothed green body is preferably conveyed through the use of off-take rollers. Particularly in the case of powders having a high density, it has been found to be advantageous to place a conveyor belt, which moves at the speed of the smoothed green body, between an off-take roller and a smoothing roller. This prevents sagging and associated stretching of the green body after leaving the smoothing roller. It is advantageous to use a cooled steel belt as the conveyor belt. The smoothed green body can be subjected to further shaping processes, for example deep drawing, embossing, bending or stamping.

If binder removal and sintering are not carried out continuously, the smoothed green body is preferably wound up on a coil. In this case, the conveyor belt is cooled so that the smoothed green body is cooled to a temperature T which lies in a range between room temperature and room temperature plus 20° C.

If sufficiently high molding composition strengths cannot be achieved for formulation related reasons, there is the plant-related opportunity of carrying out the process using carrier sheets. In this mode of operation, a plastic film or silicone paper sheet travels together with the green body on its upper side and underside into the gap between the rollers of the smoothing calender, so that no unacceptably high off-take forces can act on the enclosed green body. The carrier material is selected in such a way that no softening occurs at the given process temperatures. Polyester films and silicone release papers have been found to be particularly useful. After cooling, a coated green sheet is obtained and the two carrier sheets can be removed again therefrom by pulling them off. The use of a carrier sheet is also advantageous when the green body only solidifies slowly because of the binder formulation or adheres too strongly to the surfaces of the rollers of the smoothing calender. The use of carrier sheets is also advantageous in the event of the strength of the green sheet being insufficient, since this prevents rupture between a smoothing roller and an off-take roller.

A further variant of the process of the invention includes applying at least one further green body having a different chemical and/or physical consistency to one or both sides of the green body and joining this/these green body/bodies to the first green body through the use of a smoothing process. The green bodies can differ in the particle size of the metal powder being used. This makes it possible to control, for example, the porosity after the sintering process. If the middle green body is produced, for example, from significantly coarser, less sinter-active powder and the outer green bodies are made of a correspondingly finer powder, the sintering process results in a product which has a significantly higher porosity and thus gas or liquid permeability in the middle than in the corresponding outer zones.

Furthermore, it is also possible to incorporate expandable space reserving bodies, e.g. polystyrene beads containing blowing agent, into the green body. In this way, the green body can be foamed by appropriate treatment with hot steam, preferably at temperatures in a range of from 90 to 130° C., in a closed mold having perforated side walls. If a three-layer composite in which the middle layer is formed of a green body having expandable space reserving bodies is then produced by using the above-mentioned process, a composite body having pore-free outer surfaces and a foamed core structure is obtained after treatment with hot steam and the consolidation process. Production of a composite green body can also, as described above, be carried out by coextrusion.

Other features which are considered as characteristic for the invention are set forth in the appended claims.

Although the invention is illustrated and described herein as embodied in a process for producing an extruded shaped body, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a longitudinal-sectional view illustrating a plant layout corresponding to the process of the invention, with a single-screw extruder, a trio smoothing calender and a conveyor belt;

FIG. 2A is a longitudinal-sectional view illustrating a plant layout corresponding to the process of the invention shown in FIG. 1, but using carrier sheets; and

FIG. 2B is an enlarged view of a detail X of FIG. 2.

### DETAILED DESCRIPTION OF THE INVENTION

Reference will now be made in detail to the figures of the drawings, with which examples are described.

### Example 1

Atomized powder of steel grade 316 L having a particle size d of 25 μm measured through the use of a laser instrument was mixed at 140° C. with the following binder components in a kneading apparatus and kneaded to a minimum kneading resistance:
91.0% by weight of chromium-nickel powder
4.0% by weight of polyamide
3.0% by weight of an aromatic carboxylic ester of an aliphatic alcohol having from 12 to 22 carbon atoms
2.0% by weight of an aromatic carboxylic ester of an aliphatic alcohol having from 12 to 18 carbon atoms
3.0% by weight of a fatty acid having from 16 to 22 carbon atoms.

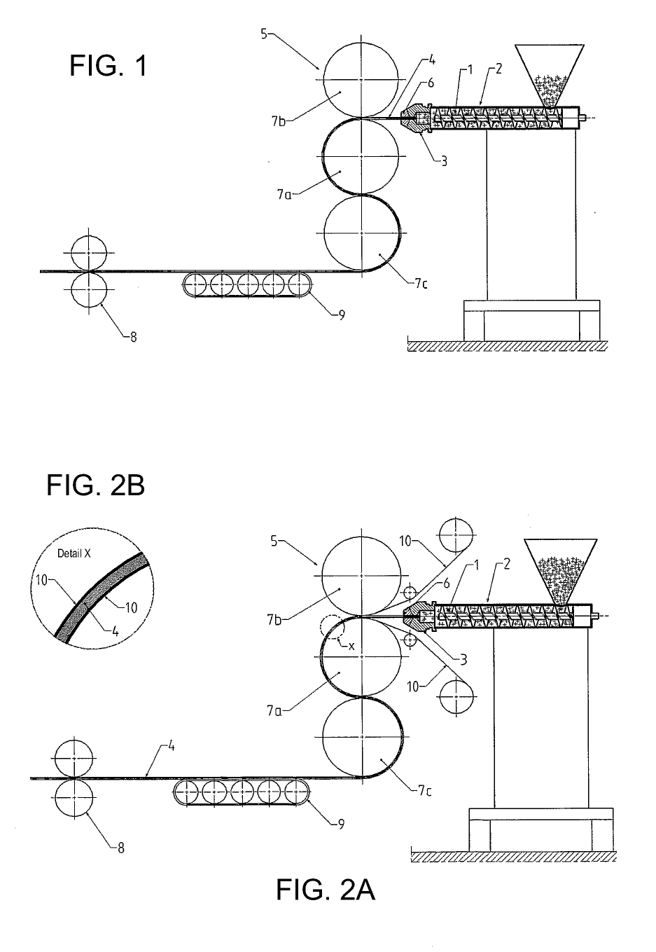

As is seen in FIG. 1, this composition was discharged from the kneading apparatus at 100° C., cooled and granulated to give a molding composition 1 having a particle diameter of about 3-4 mm. The molding composition 1 was melted through the use of a single-screw extruder 2 at barrel zone temperatures of from 80° C. to 130° C. and extruded through a slit die 3 having a gap height of 1.5 mm and a slit width of 190 mm at a die temperature of 95° C. A green body 4 produced in this way, which had a temperature of about 95° C., was fed directly into a gap between rollers of a trio smoothing calender 5, with a distance between an exit region 6 of the slip die 3 and the roller gap being about 20 mm. The green body 4 was smoothed in first and second roller gaps through the use of cooled rollers 7a, 7b and 7c to a thickness of 1.2 mm and cooled to room temperature. The smoothed green body 4 was conveyed by at least two off-take rollers 8 and a conveyor belt 9, which moves at the speed of the smoothed green body 4 and is disposed between the smoothing calender (5) and the off-take rollers 8. This process was carried out continuously.

The green body 4 was then cut to length and processed further discontinuously, firstly by partial removal of binder by chemical measures in acetone at 40° C. After 12 hours, 90% by weight of the components of the formulation, which were soluble in acetone, had been removed, so that distilling off the acetone, which had penetrated into the green body, gave an open-pored brown body having a residual binder content of about 4.5% by weight. This predominantly polymeric binder material was removed pyrolytically by heating to 600° C. at a temperature increase of 10° C./minute and a hold time of 30 minutes. The binder-free green body 4 was sintered at 1250° C. for 60 minutes. The sintered body had a good surface quality and only slight fluctuations in thickness over its area.

### Example 2

Commercial, sinterable aluminium oxide having an aluminium oxide content of at least 99.7% by weight and a particle size d measured through the use of a laser instrument of about 1.0 μm was mixed at 140° C. with the following binder components and kneaded to a minimum kneading resistance:
85.0% by weight of Al oxide powder
5.0% by weight of polyamide
7.0% by weight of an aromatic carboxylic ester of an aliphatic alcohol having from 12 to 22 carbon atoms
3.0% by weight of a fatty acid having from 16 to 22 carbon atoms.

As is seen in FIG. 2A, this composition was discharged from a kneading apparatus at 100° C., cooled and granulated to give a molding composition 1 having a particle diameter of about 3-4 mm. The molding composition 1 was melted through the use of a single-screw extruder 2 at barrel zone temperatures of from 80 to 130° C., extruded through the use of a slit die 3 having a gap thickness of 3.0 mm and a slit width of 400 mm at a die temperature of 100° C. and fed directly into a downstream trio smoothing calender 5. The distance between the slit die 3 and a first gap between the rollers of the trio smoothing calender was 20 mm. After leaving the slit die 3, the green body 4 was supported on both sides by respective carrier sheets 10, preferably of PET or silicone release paper, as seen in FIG. 2B, which move at identical speeds during subsequent process steps. The green body 4 was smoothed in the first and second roller gaps of the smoothing calender 5 to a thickness of 2.3 mm and then cooled to room temperature. A green plate produced in this way was then firstly subjected to partial chemical binder removal in acetone at 40° C. After 24 hours, about 90% by weight of the components of the formulation, which were soluble in acetone, had been removed, so that distilling off the acetone, which had penetrated into the green body, gave an open-pored brown body having a residual binder content of about 5.5% by weight. This predominantly polymeric binder material was removed pyrolytically by heating in an air furnace at 600° C. at a temperature increase of 2° C./minute and a hold time of 30 minutes. The sintering process was carried out using a temperature increase of 10° C./minute to 1650° C., with the hold time at this temperature being 1 hour. A flat aluminium oxide plate having a good surface quality and a density of more than 3.85 g/cm could be produced in this way.

1. A process for producing a shaped body, the process comprising the following steps:
producing a molding composition including from 40 to 70% by volume of metal and/or ceramic powder, from 30 to 60% by volume of a thermoplastic binder and from 0 to 5% by volume of dispersants and/or other auxiliaries;
plasticizing the molding composition in an extruder and producing a green body by discharging molding composition through a slit die;
introducing the green body into a smoothing calender;
smoothing the green body by one or more smoothing processes;
chemically and/or thermally removing binder from the smoothed green body; and
sintering the at least partially debindered green body.

2. The process according to claim 1, which further comprises feeding the green body, which has been discharged from the slit die, directly to the smoothing calender.

3. The process according to claim 1, which further comprises carrying out the plasticizing, discharging and smoothing steps continuously.

4. The process according to claim 1, which further comprises carrying out the binder removing and sintering steps continuously.

5. The process according to claim 1, which further comprises mixing and kneading the molding composition at a temperature T between 60° C. and a decomposition temperature of the binder.

6. The process according to claim 1, which further comprises selecting the extruder from the group consisting of a single-screw extruder, a twin-screw extruder, a multi-screw extruder and a cascade extruder.

7. The process according to claim 1, which further comprises combining molding compositions of the same type or different types before leaving the slit die.

8. The process according to claim 1, which further comprises selecting a processing temperature of the molding composition in the extruder of from 50 to 200° C.

9. The process according to claim 1, which further comprises controlling a temperature of an exit region of the slit die to decrease a temperature of the molding composition by from 5 to 30° C.

10. The process according to claim 1, wherein the slit die has a gap height of from 0.5 mm to 12 mm and a height to width ratio of from 1:9 to 1:600.

11. The process according to claim 1, which further comprises smoothing the green body with a smoothing roller heated to give the green body, in a roller gap, a temperature in a thermoplastic range of the binder.

12. The process according to claim 1, which further comprises smoothing the green body in a duo smoothing calender.

13. The process according to claim 1, which further comprises smoothing the green body by first and second smoothing processes in a trio smoothing calender having a middle smoothing roller, and resting the green body against the middle smoothing roller between the first and second smoothing processes.

14. The process according to claim 1, which further comprises decreasing the thickness of the green body per smoothing process by from 0 to 40%.

15. The process according to claim 1, which further comprises smoothing the green body with a structured smoothing roller.

16. The process according to claim 1, which further comprises providing the smoothed green body with a thickness of from 0.1 to 10 mm and a thickness to width ratio of from 1:10 to 1:700.

17. The process according to claim 1, which further comprises conveying the smoothed green body with at least two off-take rollers.

18. The process according to claim 1, which further comprises subjecting the smoothed green body to a shaping process selected from the group consisting of deep drawing, embossing, bending and stamping.

19. The process according to claim 1, which further comprises winding up the smoothed green body on a coil.

20. The process according to claim 17, which further comprises providing a conveyor belt, moving at a speed of the smoothed green body, between the smoothing calender and the off-take rollers.

21. The process according to claim 20, which further comprises cooling the conveyor belt for cooling the smoothed green body to a temperature T between room temperature and room temperature+20° C.

22. The process according to claim 1, which further comprises supporting the green body, after leaving the slit die, on both sides by respective carrier sheets, optionally selected from the group consisting of PET and silicone release paper, moving at identical speeds during subsequent process steps.

23. The process according to claim 1, which further comprises applying at least one further green body having a different chemical and/or physical consistency to one or both sides of the green body, and joining the at least one further green body to the green body by a smoothing process.

24. The process according to claim 23, wherein the green bodies differ in a particle size of the metal powder being used in the molding composition.

25. The process according to claim 23, wherein at least one of the green bodies contains expandable space reserving bodies optionally of polystyrene beads containing a blowing agent.

26. The process according to claim 1, wherein the thermoplastic binder is a polymer plus plasticizer.

27. The process according to claim 26, wherein the polymer is a nitrogen-containing polymer.

28. The process according to claim 27, wherein the polymer is a polyurethane or a polyamide.

29. The process according to claim 26, which further comprises providing a plasticizer selected from the group consisting of fatty acids, esters of fatty acids and fatty alcohols.

30. The process according to claim 26, wherein a volume ratio of polymer to plasticizer is from 1:1 to 1:5.7.

31. The process according to claim 1, which further comprises using a metal powder in the molding composition.

32. The process according to claim 31, which further comprises using an Fe-based alloy or a refractory metal as the metal powder.

33. The process according to claim 1, which further comprises using an oxide ceramic powder, optionally Al₂O₃, in the molding composition.

34. The process according to claim 1, which further comprises drying the smoothed green body at a temperature of from 50 to 120° C.

35. The process according to claim 1, which further comprises carrying out the thermal binder removal and sintering steps in one plant.

36. The process according to claim 1, which further comprises carrying out the thermal binder removal and sintering steps in separate plants.

37. The process according to claim 1, which further comprises heating the green body at a heating rate of <5° C./min to a temperature of from 170 to 400° C., subsequently heating the green body at a heating rate of <10° C./min to a temperature of from 500 to 800° C., and subsequently sintering the green body at a temperature corresponding to a respective solid-phase or liquid-phase sintering temperature of a material system being used.

38. The process according to claim 1, which further comprises carrying out the sintering step in such a way as to provide the shaped body with an open-pored structure.

39. The process according to claim 38, which further comprises using the shaped body having an open-pored structure in a fuel cell.

40. The process according to claim 1, which further comprises carrying out the sintering step in such a way as to provide the shaped body with a density of greater than 95% of a theoretical density.
